(19) United States
(12) Patent Application Publication
(10) Pub. No.: US 2026/0027494 A1
(43) Pub. Date: Jan. 29, 2026

(54) VAPOR SEPARATOR TANK

(71) Applicant: MIKUNI CORPORATION, Tokyo (JP)

(72) Inventor: Takumi Oikawa, Odawara-shi (JP)

(21) Appl. No.: 19/230,423

(22) Filed: Jun. 6, 2025

(30) Foreign Application Priority Data
Jul. 26, 2024 (JP) 2024-121130

(51) Int. Cl. B01D 19/00; F02M 33/02

(52) U.S. Cl. CPC B01D 19/0042; F02M 33/02

(57) ABSTRACT

A VST (vapor separator tank) includes a casing including a lower case and an upper case joined to each other and having a fuel storage compartment formed therein to store liquid fuel, a pump arranged in the casing and pumping the liquid fuel stored in the fuel storage compartment, and a regulator (pressure regulator) sandwiched by the lower case and the upper case inside an accommodation space formed in the casing, and adjusting a discharge pressure of the pump to be constant. The casing includes a regulator support portion abutting on and supporting the regulator. Disclosed embodiments provide a vapor separator tank capable of holding a pressure regulator with a simpler structure and suppressing an increase in the number of parts, man-hours for assembly, and manufacturing costs.

### CROSS-REFERENCE TO RELATED APPLICATION(S)

The present application claims priority to Japanese patent application Serial No. 2024-121130, filed Jul. 26, 2024, the content of which is hereby incorporated by reference in its entirety.

### BACKGROUND OF THE INVENTION

### Field of the Invention

The present invention relates to a vapor separator tank.

### Description of the Related Art

Heretofore, a technology related to a vapor separator tank including a pressure regulator has been known. For example, Japanese Patent Laid-Open No. 2011-73630 describes a vapor separator tank in which a pressure regulator is sandwiched and accommodated between a lower case forming a fuel storage compartment and an upper case closing an upper opening of the lower case.

### SUMMARY OF THE INVENTION

However, in the structure described in Japanese Patent Laid-Open No. 2011-73630 mentioned above, the pressure regulator is supported by arranging a holder (housing) and an O-ring between the lower case and the pressure regulator. When such a holder and fixtures for attaching the holder to the casing is used, the number of parts and man-hours for assembly increases. Moreover, it may be necessary to prepare dedicated fixing parts, which may lead to an increase in manufacturing costs.

The present invention has been made in view of such problems, and aims to provide a vapor separator tank capable of supporting a pressure regulator with a simpler structure and suppressing an increase in the number of parts, man-hours for assembly, and manufacturing costs.

A vapor separator tank according to embodiments of the present invention can be a vapor separator tank separating gas from liquid fuel to be supplied to an internal combustion engine, the vapor separator tank including: a casing including a lower case and an upper case joined to each other and having a fuel storage compartment formed therein to store the liquid fuel; a pump pumping the liquid fuel stored in the fuel storage compartment; and a pressure regulator sandwiched by the lower case and the upper case inside an accommodation space communicating with the fuel storage compartment, and adjusting a discharge pressure of the pump to be constant, in which the casing includes a regulator support portion abutting on and supporting the pressure regulator.

The pressure regulator may include a flange portion protruding radially outward from an outer peripheral surface thereof, and the regulator support portion may include a protrusion formed in the lower case, covering the outer peripheral surface of a lower part of the pressure regulator from the radially outer side, and abutting on the flange portion from below.

The regulator support portion may include a recess formed in the upper case at a position facing the protrusion in an up-down direction and sandwiching the flange portion with the protrusion.

The regulator support portion may include a bottom surface portion closing a lower part of the pressure regulator on an inner peripheral side of the protrusion, and a cutout connecting spaces on the inner peripheral side and an outer peripheral side of the protrusion to distribute the liquid fuel to the fuel storage compartment may be formed in the protrusion.

The regulator support portion may have a part located below the pressure regulator on the inner peripheral side of the protrusion open and communicating with the fuel storage compartment.

Of the lower case, a part facing a lower surface of the pressure regulator may extend obliquely toward a center of the fuel storage compartment from the pressure regulator side toward the lower side.

Since the casing supports the pressure regulator directly in the vapor separator tank of the present invention, fixing parts for supporting the pressure regulator to the casing, fixtures for attaching the fixing parts to the casing, and specialization thereof are unnecessary. Hence, according to the vapor separator tank of the present invention, it is possible to support the pressure regulator with a simpler structure and suppress an increase in the number of parts, man-hours for assembly, and manufacturing costs.

The present summary is provided only by way of example, and not limitation. Other aspects of the present invention will be appreciated in view of the entirety of the present disclosure, including the entire text, claims, and accompanying figures.

### BRIEF DESCRIPTION OF THE DRAWINGS

FIG. 1 is a side view schematically illustrating an outboard motor including a vapor separator tank according to an embodiment;

FIG. 2 is a plan view schematically illustrating the outboard motor;

FIG. 3 is a side view illustrating the vapor separator tank;

FIG. 4 is a plan view illustrating the vapor separator tank;

FIG. 5 is a cross-sectional view taken along line A-A of FIG. 4;

FIG. 6 is an enlarged cross-sectional view illustrating the vicinity of a regulator support portion;

FIG. 7 is a perspective view illustrating the vicinity of the regulator support portion from which a regulator is removed;

FIG. 8 is a perspective view illustrating the vicinity of the regulator support portion to which the regulator is attached; and

FIG. 9 is an enlarged cross-sectional view illustrating another configuration example of the regulator support portion.

While the above-identified figures set forth one or more embodiments of the present invention, other embodiments are also contemplated as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps, and/or components not specifically shown in the drawings.

### DETAILED DESCRIPTION OF THE INVENTION

Hereinafter, an embodiment of the present invention will be described with reference to the drawings.

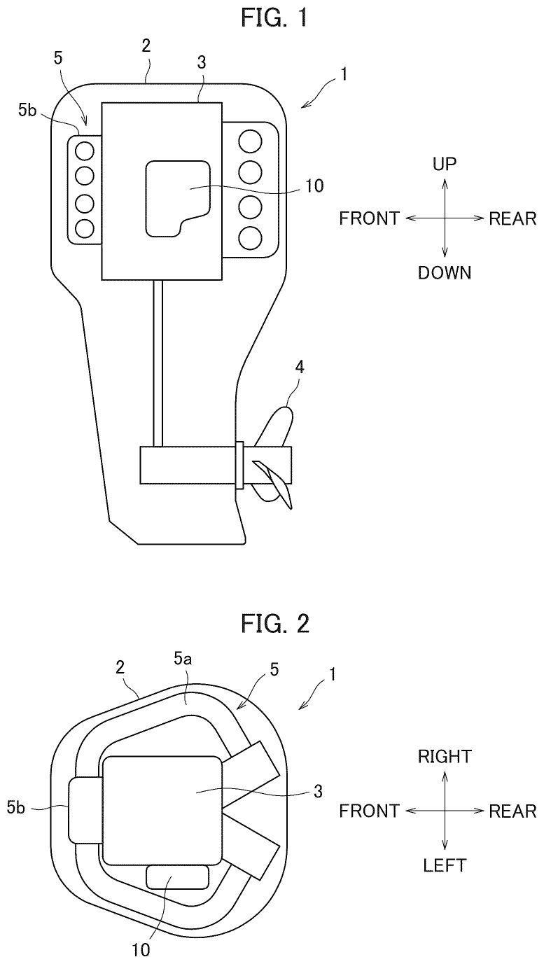

FIG. 1 is a side view schematically illustrating an outboard motor including a vapor separator tank according to the embodiment. FIG. 2 is a plan view schematically illustrating the outboard motor. Hereinbelow, configurations will be described on the basis of a front-rear direction, a left-right direction, and an up-down direction of a ship (not illustrated) on which an outboard motor 1 is mounted. The outboard motor 1 is mounted on the ship and rotates a propeller 4 by the motive force of a multi-cylinder engine (internal combustion engine) 3 mounted inside a main body case 2. As illustrated in FIG. 2, a plurality of intake pipes 5a included in an intake manifold 5 for drawing in air to the engine 3 are arranged to extend from a mixing body 5b in the front-rear direction apart from a side surface of the engine 3 inside the main body case 2. Note that the plurality of intake pipes 5a are omitted from FIG. 1.

The outboard motor 1 includes a vapor separator tank 10 (referred to as “VST 10” below) having a gas-liquid separation function of temporarily storing liquid fuel to be supplied to the engine 3 and separating gas such as evaporated gas and bubbles in the liquid fuel. The VST 10 is connected between the engine 3 and a fuel tank (not illustrated) storing liquid fuel, and is supplied with liquid fuel from the fuel tank by a low-pressure pump (not illustrated). In the present embodiment, the VST 10 is attached to a front surface of the engine 3. The VST 10 is arranged in a space between the side surface of the engine 3 and the intake manifold 5 in the present embodiment, but it may be arranged on a front surface of the engine 3, for example.

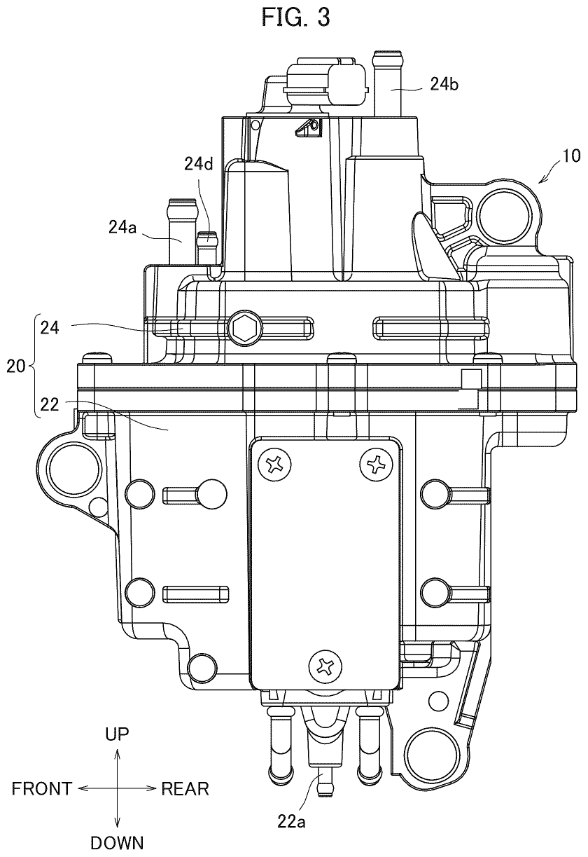

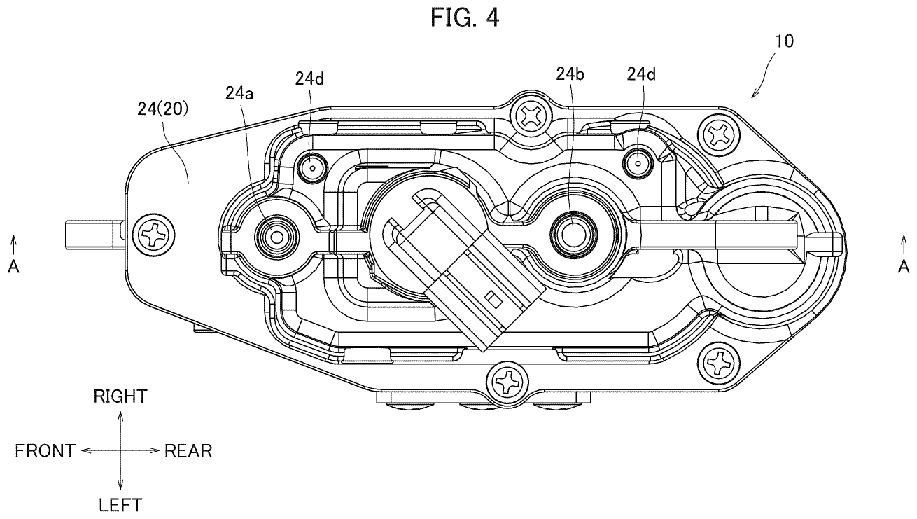

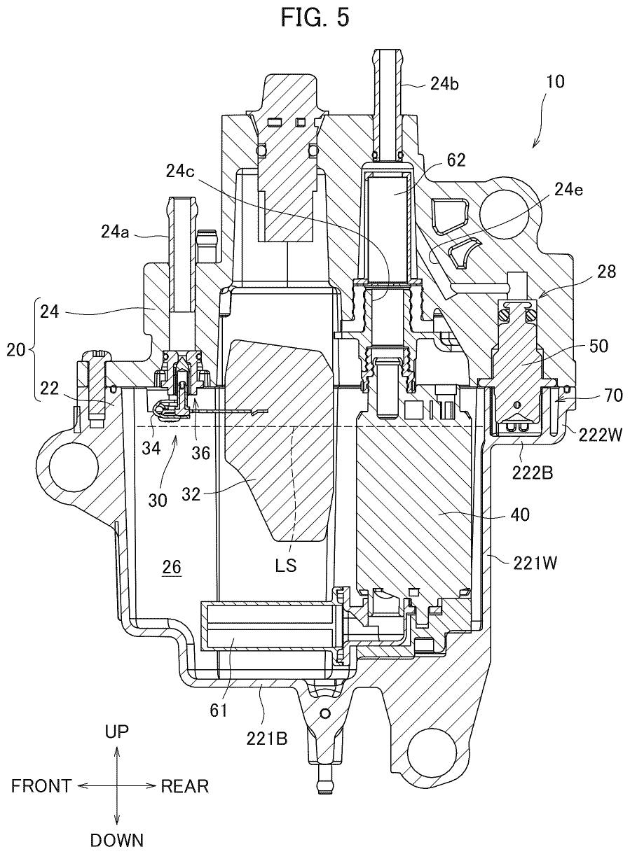

Hereinafter, a specific configuration of the VST 10 will be described with reference to FIGS. 3 to 5. FIG. 3 is a side view illustrating the VST 10, FIG. 4 is a plan view illustrating the VST 10, and FIG. 5 is a cross-sectional view taken along line A-A of FIG. 4. As illustrated in FIG. 5, the VST 10 includes a casing 20, a float mechanism 30, a pump 40, and a pressure regulator 50 (referred to as “regulator 50” below).

The casing 20 includes a lower case 22 and an upper case 24. The lower case 22 forms a fuel storage compartment 26 that stores liquid fuel. The fuel storage compartment 26 is a space surrounded by a first bottom surface portion 221B of the lower case 22 and a first side wall portion 221W extending upward from the first bottom surface portion 221B. A drain outlet 22a for discharging fuel when not using the internal combustion engine for a long time during maintenance or off-season is formed in a lower portion of the lower case 22.

The upper case 24 is a lid-shaped member closing an upper opening of the lower case 22, and is joined to the lower case 22 using a fastener. The upper case 24 is provided with a fuel inlet 24a to which liquid fuel from the fuel tank flows in, and a fuel outlet 24b from which liquid fuel to be supplied to the engine 3 side flows out. The fuel outlet 24b communicates with a discharge channel 24c connected to the pump 40 described later. Additionally, the upper case 24 is provided with two air vents 24d that discharge gas such as evaporated fuel and bubbles from the liquid fuel to the outside.

The float mechanism 30 includes a float 32, a hinge 34, and a float valve 36. The float 32 is swingably supported by the upper case 24 via the hinge 34, and is floated in liquid fuel inside the fuel storage compartment 26. The float 32 moves with upward and downward movement of a liquid surface LS of the liquid fuel indicated by a broken line in FIG. 5. Additionally, the hinge 34 is configured to move up and down together with the float valve 36 provided in a channel communicating with the fuel inlet 24a.

With this configuration, when the amount of liquid fuel inside the fuel storage compartment 26 is less than a predetermined reference value, the float 32 is located below a predetermined position, whereby the hinge 34 pushes down a valve body of the float valve 36 to open the float valve 36. As a result, liquid fuel flows into the fuel storage compartment 26 from the fuel inlet 24a. On the other hand, when the amount of liquid fuel inside the fuel storage compartment 26 is equal to or more than the reference value, the float 32 moves to the upper side of the predetermined position, whereby the hinge 34 pushes up the valve body of the float valve 36 to close the float valve 36. As a result, the flow of liquid fuel into the fuel storage compartment 26 from the fuel inlet 24a is restricted. Accordingly, the amount of liquid fuel inside the fuel storage compartment 26 is adjusted to be constant.

The pump 40 is a high-pressure pump mounted inside the casing 20 and pumping liquid fuel stored in the fuel storage compartment 26. A first filter 61 filtering the liquid fuel inside the fuel storage compartment 26 is connected to a suction port of the pump 40. On the other hand, a discharge port of the pump 40 is connected to the discharge channel 24c formed in the upper case 24, and liquid fuel discharged from the pump 40 is guided to the fuel outlet 24b via the discharge channel 24c and pumped to the engine 3 side. Additionally, a second filter 62 filtering liquid fuel is arranged in an intermediate portion of the discharge channel 24c.

The regulator 50 is arranged in an accommodation space 28 defined by the lower case 22 and the upper case 24 and communicating with the fuel storage compartment 26. The accommodation space 28 is connected to a relief channel 24e communicating with an intermediate portion of the discharge channel 24c. The regulator 50 includes a valve body, a valve seat portion, a spring, and other components (not illustrated) in a substantially cylindrical case, and opens in response to the increase in pressure of fuel flowing into the relief channel 24e to return excess fuel to the fuel storage compartment 26. With this configuration, the discharge pressure of the pump 40, that is, the pressure of liquid fuel to be supplied to the engine 3, is adjusted to be constant.

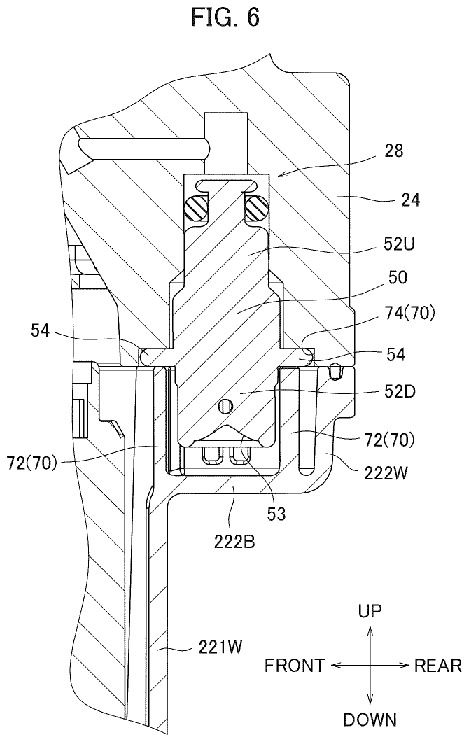

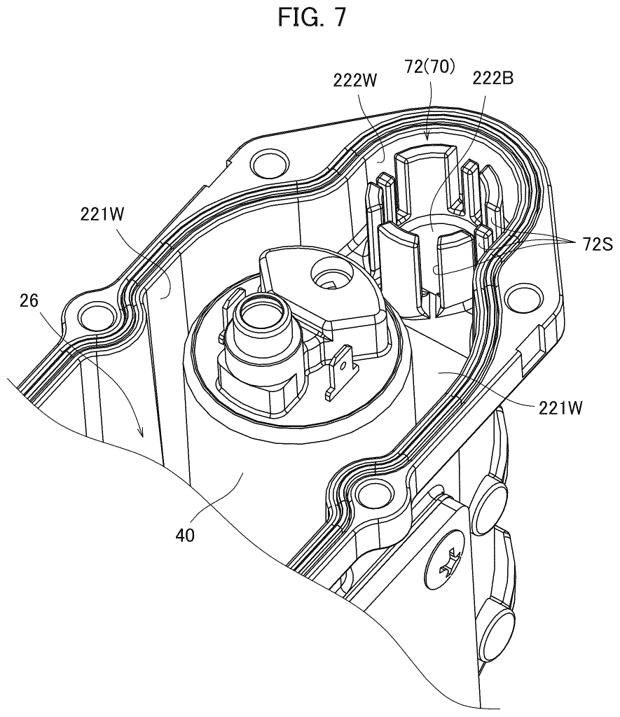

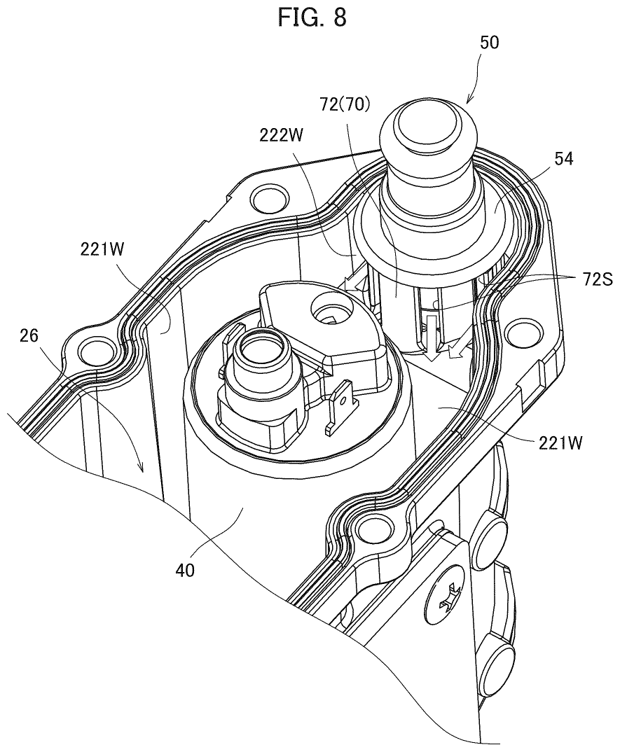

Next, a support structure of the regulator 50 will be described. FIG. 6 is an enlarged cross-sectional view illustrating the vicinity of the regulator support portion, FIG. 7 is a perspective view illustrating the vicinity of a regulator support portion from which the regulator 50 is removed, and FIG. 8 is a perspective view illustrating the vicinity of the regulator support portion to which the regulator 50 is attached. In the present embodiment, as illustrated in FIG. 6, a case of the regulator 50 includes an upper case 52U and a lower case 52D. A flange portion 54 protruding toward the outside in the radial direction of the regulator 50 in a disk shape from an outer peripheral surface is formed in a connection portion of the upper case 52U and the lower case 52D.

The regulator 50 configured in this manner is arranged in the accommodation space 28 as described above. Of the accommodation space 28, a part defined by the lower case 22 is a space surrounded by a second bottom surface portion (bottom surface portion) 222B located higher than the first bottom surface portion 221B and a second side wall portion 222W extending upward from the second bottom surface portion 222B, and communicates with the fuel storage compartment 26. As illustrated in FIG. 7, the second bottom surface portion 222B extends to the rear side in the front-rear direction from a part of the first side wall portion 221W. The second bottom surface portion 222B is a part facing a lower surface 53 of the regulator 50 from which the liquid fuel flows out, extends horizontally at a position near the lower surface 53, and is configured to close the lower part of the regulator 50. The second side wall portion 222W is continuous with the first side wall portion 221W extending at the same height.

Then, the regulator 50 is supported by a regulator support portion 70 formed by the lower case 22 and the upper case 24 inside the accommodation space 28. The regulator support portion 70 includes the second bottom surface portion 222B, an annular protrusion (protrusion) 72 formed in the second bottom surface portion 222B, and an annular recess (recess) 74 formed in the upper case 24. The annular protrusion 72 is provided apart from the second side wall portion 222W and protrudes upward in a ring shape from the second bottom surface portion 222B. The annular protrusion 72 is larger in diameter than the lower case 52D of the regulator 50 and smaller in diameter than the flange portion 54. As illustrated in FIG. 8, the annular protrusion 72 covers an outer peripheral surface of the lower case 52D of the regulator 50 from the radially outer side and abuts on the flange portion 54 from below. That is, the regulator 50 is supported by the annular protrusion 72 at the flange portion 54 with the lower case 52D accommodated on the inner peripheral side of the annular protrusion 72. Accordingly, the annular protrusion 72 is set at a height such that, when in abutting on the flange portion 54, at least the lower case 52D does not interfere with the second bottom surface portion 222B. Note that a part of the annular protrusion 72 may be formed not to abut on the flange portion 54.

As illustrated in FIG. 6, the annular recess 74 is a ring-shaped depression formed in the upper case 24 at a position facing the annular protrusion 72 in the up-down direction. The annular recess 74 formed slightly larger in diameter than the flange portion 54. The regulator 50 is positioned by the flange portion 54 being accommodated in a space surrounded by the annular protrusion 72 and the annular recess 74, and the flange portion 54 is sandwiched by the annular protrusion 72 and the annular recess 74 from upper and lower sides when the lower case 22 and the upper case 24 are joined together. As a result, the regulator 50 is fixed inside the accommodation space 28.

Moreover, the annular protrusion 72 has a plurality of cutouts 72S extending in the up-down direction from the second bottom surface portion 222B. The plurality of cutouts 72S are spaced apart from each other in the circumferential direction of the annular protrusion 72. With this configuration, as indicated by white arrows in FIG. 8, liquid fuel flowing out of the regulator 50 is returned to the fuel storage compartment 26 through the cutouts 72S and gaps between the annular protrusion 72 and the second side wall portion 222W. Thus, the plurality of cutouts 72S connect spaces on the inner and outer peripheral sides of the annular protrusion 72 to distribute the liquid fuel.

As described above, the VST (vapor separator tank) 10 according to the embodiment includes the casing 20 having the lower case 22 and the upper case 24 joined to each other and the fuel storage compartment 26 formed therein to store liquid fuel, the pump 40 arranged inside the casing 20 and pumping liquid fuel stored in the fuel storage compartment 26, and the regulator (pressure regulator) 50 sandwiched by the lower case 22 and the upper case 24 inside the accommodation space formed in the casing 20 and adjusting the discharge pressure of the pump 40 to be constant. The casing 20 includes the regulator support portion 70 abutting on and supporting the regulator 50.

With this configuration, since the casing 20 supports the regulator 50 directly, fixing parts for supporting the regulator 50 to the casing 20, fixtures for attaching the fixing parts to the casing 20, and specialization thereof are unnecessary. Hence, according to the VST 10 according to the embodiment, it is possible to support the regulator 50 with a simpler structure and suppress an increase in the number of parts, man-hours for assembly, and manufacturing costs.

Additionally, the regulator 50 includes the flange portion 54 protruding radially outward from the outer peripheral surface thereof, and the regulator support portion 70 includes the annular protrusion (protrusion) 72 covering the outer peripheral surface of the lower case (lower portion) 52D of the regulator 50 from the radially outer side and abutting on the flange portion 54 from below. With this configuration, the regulator 50 can be supported easily just by placing the flange portion 54 on the annular protrusion 72.

Moreover, the regulator support portion 70 includes the annular recess (recess) 74 formed in the upper case 24 at a position facing the annular protrusion 72 in the up-down direction and sandwiching the flange portion 54 with the annular protrusion 72. With this configuration, the regulator 50 can be supported more stably by sandwiching the flange portion 54 by the annular protrusion 72 and the annular recess 74.

In addition, the regulator support portion 70 includes the second bottom surface portion (bottom surface portion) 222B closing the lower part of the regulator 50 on the inner peripheral side of the annular protrusion 72, and the cutouts 72S for distributing the liquid fuel to the fuel storage compartment 26 are formed in the annular protrusion 72. With this configuration, liquid fuel from the regulator 50 can be temporarily received by the second bottom surface portion 222B and then be returned to the fuel storage compartment 26 through the cutouts 72S. As a result, it is possible to suppress generation of bubbles compared to a case where liquid fuel flows directly into the fuel storage compartment 26 from the regulator 50. Note that the second bottom surface portion 222B is preferably provided near the lower surface 53 of the regulator 50 to obtain the bubble elimination effect. Additionally, the second bottom surface portion 222B is more preferably located lower than the level of the liquid surface LS to be maintained by the float mechanism 30. Note that it is even more preferable that the lower surface 53 of the regulator 50 is located lower than the liquid surface LS.

Furthermore, by adjusting the shape and size of the cutout 72S such as the width, height, and opening position, bubbles in the liquid fuel can be eliminated even more effectively. As a result, there is no need to attach a separate bubble elimination cover to the regulator 50, so that the number of parts and man-hours for assembly can be reduced. Additionally, by adjusting the shape and size of the cutout 72S such as the width, height, and opening position, it is possible to suppress flowing of liquid fuel containing bubbles discharged from the regulator 50 toward the suction port of the pump 40, for example, and adjust the flow direction of the liquid fuel. Note that the cutout 72S is not limited to the shape extending in the up-down direction, and may be provided in another shape such as a lattice shape or the shape of a plurality of holes.

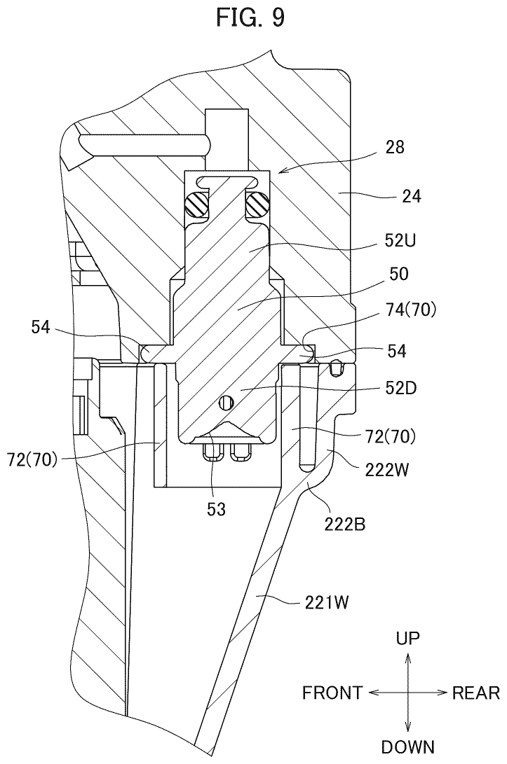

FIG. 9 is an enlarged cross-sectional view illustrating another configuration example of the regulator support portion. As illustrated in FIG. 9, the second bottom surface portion 222B does not have to close the entire lower part of the regulator 50. That is, the second bottom surface portion 222B only needs to include the part extending on the outer peripheral side of the annular protrusion 72 to enable formation of the annular protrusion 72, and the part on the inner peripheral side of the annular protrusion 72 may be open and communicating with the fuel storage compartment 26. In the example illustrated in FIG. 9, the part facing the lower surface 53 of the regulator 50 is formed as a part of the first side wall portion 221W forming the fuel storage compartment 26. As illustrated in FIG. 9, the first side wall portion 221W extends obliquely toward the center of the fuel storage compartment 26, which is toward the front side in the front-rear direction in this example, from the regulator 50 toward the lower side.

With this configuration, it is possible to return the liquid fuel from the regulator 50 to the fuel storage compartment 26 without forming the plurality of cutouts 72S in the annular protrusion 72. Additionally, by adjusting the angle of the first side wall portion 221W, it is possible to guide the liquid fuel from the regulator 50 into the fuel storage compartment 26 along the first side wall portion 221W smoothly and in a desired direction. For example, the first side wall portion 221W may extend obliquely downward from the second bottom surface portion 222B and extend vertically downward from an intermediate portion thereof. As a result, it is possible to suppress flowing of the liquid fuel containing bubbles along the first side wall portion 221W toward the suction port of the pump 40 even more effectively. Moreover, the first side wall portion 221W may extend obliquely downward at a first predetermined angle from the second bottom surface portion 222B, and extend at a second predetermined angle gentler than the first predetermined angle from an intermediate portion thereof. Moreover, the first side wall portion 221W may include a depression portion bulging toward the outside of the lower case 22 in an intermediate portion thereof. As a result, it is possible to slow down the flow of the liquid fuel containing bubbles along the first side wall portion 221W and suppress the flowing of the fuel toward the suction port of the pump 40 even more effectively. Additionally, a fin-shaped portion or the like for adjusting the flow direction of the liquid fuel may be provided in the first side wall portion 221W.

Although the embodiment has been described above, the mode of the present invention is not limited to this embodiment. For example, the annular protrusion 72 and the annular recess 74 do not have to be ring-shaped as long as they sandwich the flange portion 54 and do not interfere with other parts of the regulator 50. Additionally, the regulator support portion 70 may be formed in a shape different from that of the embodiment as long as it is a structure that abuts on and supports the regulator 50. In that case, the shape of the regulator support portion 70 preferably takes into account adjusting the flow direction of liquid fuel from the regulator 50 and eliminating bubbles as described earlier.

### REFERENCE SIGNS LIST

1 outboard motor
3 engine (internal combustion engine)
10 vapor separator tank (VST)
20 casing
22 lower case
222B second bottom surface portion (bottom surface portion)
24 upper case
26 fuel storage compartment
28 accommodation space
30 float mechanism
40 pump
50 pressure regulator (regulator)
54 flange portion
70 regulator support portion
72 annular protrusion (protrusion)
72S cutout
74 annular recess (recess)

Although the present invention has been described with reference to preferred embodiments, workers skilled in the art will recognize that changes may be made in form and detail without departing from the spirit and scope of the invention.

What is claimed is:

1. A vapor separator tank separating gas from liquid fuel to be supplied to an internal combustion engine, the vapor separator tank comprising:
a casing including a lower case and an upper case joined to each other and having a fuel storage compartment formed therein to store the liquid fuel;
a pump pumping the liquid fuel stored in the fuel storage compartment; and
a pressure regulator sandwiched by the lower case and the upper case inside an accommodation space communicating with the fuel storage compartment, and adjusting a discharge pressure of the pump to be constant, wherein
the casing includes a regulator support portion abutting on and supporting the pressure regulator.

2. The vapor separator tank according to claim 1, wherein
the pressure regulator includes a flange portion protruding radially outward from an outer peripheral surface thereof, and
the regulator support portion includes a protrusion formed in the lower case, covering the outer peripheral surface of a lower part of the pressure regulator from a radially outer side, and abutting on the flange portion from below.

3. The vapor separator tank according to claim 2, wherein the regulator support portion includes a recess formed in the upper case at a position facing the protrusion in an up-down direction and sandwiching the flange portion with the protrusion.

4. The vapor separator tank according to claim 2, wherein
the regulator support portion includes a bottom surface portion closing a lower part of the pressure regulator on an inner peripheral side of the protrusion, and
a cutout connecting spaces on the inner peripheral side and an outer peripheral side of the protrusion to distribute the liquid fuel to the fuel storage compartment is formed in the protrusion.

5. The vapor separator tank according to claim 2, wherein the regulator support portion has a part located below the pressure regulator on the inner peripheral side of the protrusion open and communicating with the fuel storage compartment.

6. The vapor separator tank according to claim 5, wherein, of the lower case, a part facing a lower surface of the pressure regulator extends obliquely toward a center of the fuel storage compartment from a pressure regulator side toward the lower side.
